(19) United States
(12) Patent Application Publication
(10) Pub. No.: US 2021/0088353 A1
(43) Pub. Date: Mar. 25, 2021

(54) MARKERS DESCRIBING THE ENVIRONMENT OF A GEOGRAPHIC LOCATION

(71) Applicant: BaseMap, Inc., Bothell, WA (US)

(72) Inventors: Chris Barrow, Bothell, WA (US); Jeffrey Balch, Bothell, WA (US)

(21) Appl. No.: 16/847,405

(22) Filed: Apr. 13, 2020

Related U.S. Application Data
(60) Provisional application No. 62/904,945, filed on Sep. 24, 2019.

(51) Int. Cl. G01C 21/36; G06F 16/29; H04W 4/021

(52) U.S. Cl. CPC G01C 21/367; H04W 4/021; G06F 16/29; G01C 21/3694

(57) ABSTRACT

A facility creates a geographic marker describing a geographic location. The facility receives user input specifying the creation of a geographic marker at a distinguished date and time. The facility responds to the user input by determining a mobile device's geographic location at the distinguished date and time. The facility then stores its geographic location and the distinguished date and time as a geographic marker.

### CROSS-REFERENCE TO RELATED APPLICATIONS

This application claims the benefit of provisional U.S. Application No. 62/904,945, filed Sep. 24, 2019 and entitled “Smart Markers,” which is hereby incorporated by reference in its entirety.

In cases where the present application conflicts with a document incorporated by reference, the present application controls.

### BACKGROUND

Hikers, hunters, fishermen, and other outdoors-people spend time in a variety of outdoor settings, such as trails, forests, rivers, lakes, etc. While in those settings it is common for them to record information about the environment and location to detect any patterns associated with wildlife. They do so by, for example, keeping detailed notes on a notepad or a note-taking device; taking photos of their surroundings; keeping track of their own movements using a map, compass, and/or GPS; and using various other devices to obtain information about the weather and environmental conditions at their location.

### BRIEF DESCRIPTION OF THE SEVERAL VIEWS OF THE DRAWINGS

FIG. 1 is a block diagram showing some of the components typically incorporated in at least some of the mobile devices or computer systems on which the facility operates.

FIG. 2 is a sample marker selection screen, presented by the facility in some embodiments.

FIG. 3 is a flow diagram showing a process performed by the facility in some embodiments to create a geographic marker.

FIG. 4 is a sample location selection screen presented by the facility in some embodiments.

FIG. 5 is a sample marker log screen presented by the facility in some embodiments.

FIG. 6 is a sample marker weather conditions screen presented by the facility in some embodiments.

FIG. 7 is a sample data adjustment screen presented by the facility in some embodiments.

FIG. 8 is a sample geographic marker data structure used by the facility in some embodiments.

FIG. 9 is a flow diagram showing a process performed by the facility in some embodiments to create an image marker.

FIG. 10 is a sample add photo prompt, used by the facility in some embodiments.

FIG. 11 depicts a sample location selection screen for image marker presented by the facility in some embodiments.

FIG. 12 depicts a sample image marker data structure, used by the facility in some embodiments.

FIG. 13 is a flow diagram showing a process performed by the facility in some embodiments to create a path.

FIG. 14 is a sample path start screen, presented by the facility in some embodiments.

FIG. 15 is a sample path map screen, presented by the facility in some embodiments.

FIG. 16 is a sample path progress screen, presented by the facility in some embodiments.

FIG. 17 is a sample path log screen, presented by the facility in some embodiments.

FIG. 18 is a sample path weather conditions screen, presented by the facility in some embodiments.

FIG. 19 is a sample path data structure, used by the facility in some embodiments.

FIG. 20 is a sample path display screen, presented by the facility in some embodiments.

### DETAILED DESCRIPTION

The inventors have identified numerous disadvantages of conventional manual approaches to obtaining and recording information about an outdoors-person's surroundings. First, in addition to the hiking, hunting, fishing, or other gear the outdoors-person may have, they must also bring tools to take notes, capture images, keep track of their location, and record any other information they would like to track. Thus, this practice adds to the total number of items an outdoors-person must carry, and leaves less space for other tools and gear they require, such as a fishing rod and reel, bait, and tackle in the case of a fisherman.

Additionally, the outdoors-person must frequently stop and record data describing their surroundings or the weather and mark their current location on a map, in order to keep track of where they are and what is around them. The alternative to stopping to record this information would be to mentally record and memorize the information, and then either reference the information or record the information at a later time. Thus, an outdoors-person would need to stop their enjoyment of nature in order to record data they would like to track. Additionally, in the case of memorizing the information, they may misremember or forget information they had planned to record.

When weather data beyond simple conditions like temperature and precipitation is important to an outdoors-person, such as humidity, the state of the tides, or barometric pressure, they must either: carry tools and devices to track that data; or remember and/or record the time and area they were in, then access a repository of weather information to obtain more detailed information. This type of data can be used to recreate their experience or to help determine the habits of certain wildlife they may have encountered.

In response to the inventors' recognition of these disadvantages, they have conceived and reduced to practice a software and/or hardware facility for automatically or semi-automatically recording an outdoors-person's location and recording data describing the weather and other environmental information at that location while the outdoors-person is there. In some embodiments, the facility is implemented as a mobile application installed on a smartphone, used by an outdoors-person (“the user”), and retrieves data from the smartphone's sensors, user input, and/or a third-party data source to record the data describing the weather and surroundings at that location.

In various embodiments, the third-party data source includes data from a nearby weather station. In various embodiments, the third-party data source includes crowd-sourced data, such as data gathered by other users in the area. In various embodiments, the third-party data source includes data from a computer network, such as the Internet.

In some embodiments, the facility places a virtual marker on a map that represents a user's location in the real world. In some embodiments, the facility automatically populates the virtual marker with data describing the weather and other environmental information at the time the user was present in that location. In some embodiments, the virtual marker contains data describing the weather and other environmental information at a time before the user was present in that location. In some embodiments, the virtual marker contains data describing the weather and other environmental information at a time after the user was present in that location.

In some embodiments, the facility displays the data contained in the virtual marker to a user. In some embodiments, the facility allows a user to share the data contained in the virtual marker with others, such as via a social networking platform. In some embodiments, the facility allows the user to view the current weather and environmental information data for the marker's real-world location.

In some embodiments, the facility automatically or semi-automatically tracks the user's movements, and records data describing the user's surroundings and the weather in that area as they move. In some embodiments, the facility allows a user to capture images, and associates those images with the user's environment at the location and time the image was captured. In some embodiments, the facility allows the user to share the data collected during their time outside with other users. In some embodiments, the facility allows the user to share the data collected during their time outside to a third-party social media service. In some embodiments, the facility allows the user to access the current weather and other environment information for a previously created virtual marker to determine if they wish to return to that location.

By performing in some or all of the ways discussed above, the facility enables users to quickly and easily gather data describing their surroundings, both in a single location and as they move to other locations.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with less latency, and/or preserving more of the conserved resources for use in performing other tasks or additional instances of the same task. As one example, the facility performs the tasks of multiple devices, including devices to take notes, record weather data, track location, and capture images, in one device and automatically or semi-automatically records the information captured from those devices, thereby avoiding the need to allocate as much processing power, storage, and computing resources to create user interfaces that allow a user to manually input weather and other environment information.

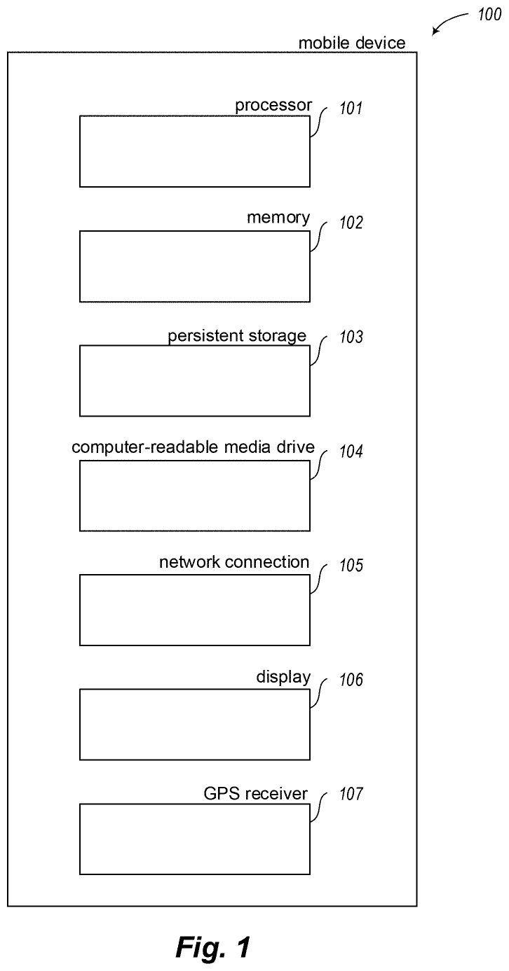

FIG. 1 is a block diagram showing some of the components typically incorporated in at least some of the mobile devices or computer systems on which the facility operates. In various embodiments, these mobile devices and other devices or computer systems 100 can include mobile phones, tablet computers, personal digital assistants, laptop computer systems, netbooks, cameras, automobile computers, electronic media players, etc. In various embodiments, the mobile devices or other computer systems include zero or more of each of the following: a central processing unit (“CPU”) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a SD-card, floppy, CD-ROM, or DVD drive, for reading programs and data stored on a computer-readable medium; a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like; a display 106 for displaying visual information or data to a user; and a GPS receiver 107 for determining the mobile device's 100 geographic location using GPS or another positioning system. While computer systems configured as described above are typically used to support the operation of the facility, those skilled in the art will appreciate that the facility may be implemented using devices of various types and configurations, and having various components.

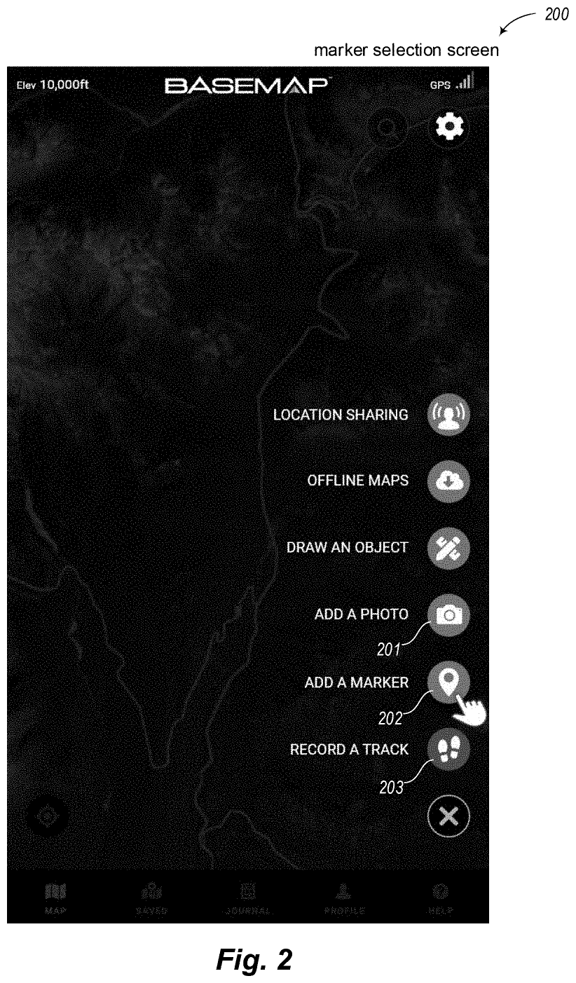

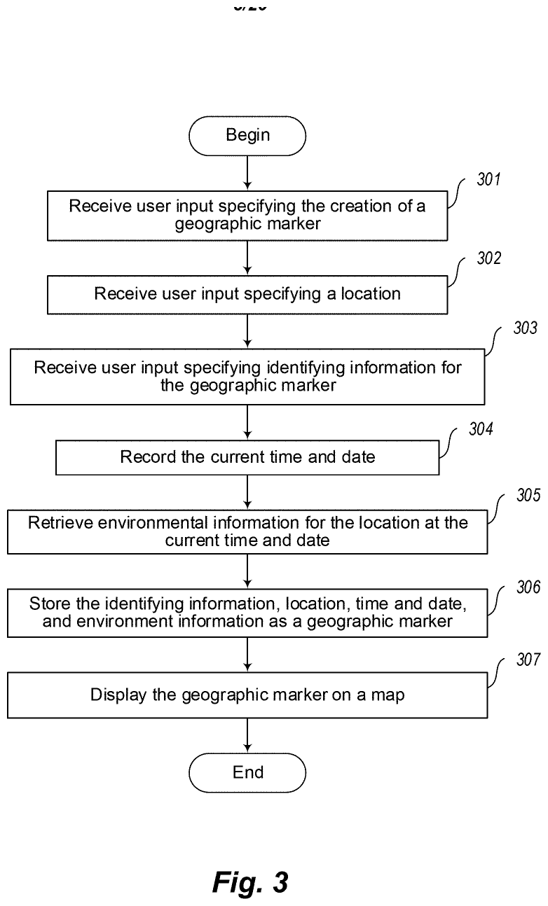

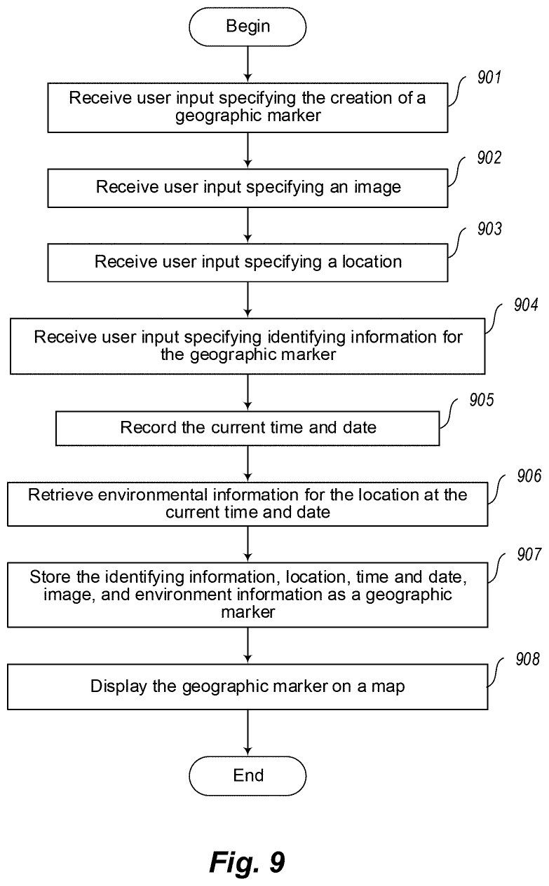

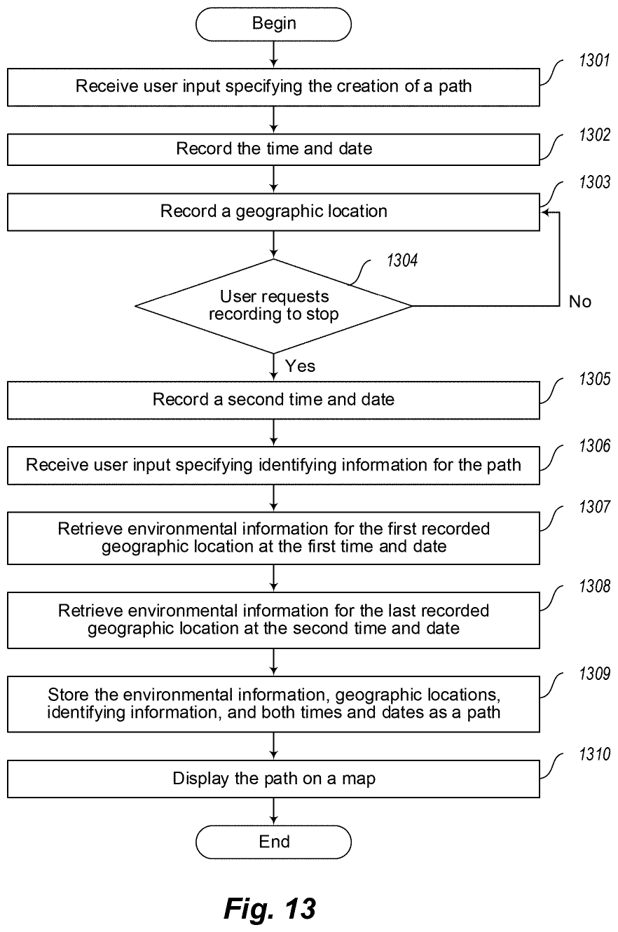

FIG. 2 is a sample marker selection screen 200, presented by the facility in some embodiments. The marker selection screen 200 includes an add photo button 201, an add marker button 202, and a record track button 203. When a user activates the add marker button 202, such as by touching it, the facility creates a geographic marker by performing the process described by FIG. 3. When a user activates the add photo button 201, the facility creates an image marker—a geographic marker that includes an image—by performing the process described by FIG. 9. When a user activates the record track button 203, the facility creates a path capturing the route taken by the user by performing the process described by FIG. 13. In some embodiments, the facility displays the add photo button 201, add marker button 202, and record track button 203, in response to receiving a user interaction, such as pressing an options button 1303, depicted in FIG. 13.

FIG. 3 is a flow diagram showing a process performed by the facility in some embodiments to create a geographic marker. In act 301, the facility receives user input specifying the creation of a geographic marker, such as selection of the add marker button 202 shown in FIG. 2. In act 302, the facility receives user input specifying a location for the geographic marker. In some embodiments, the facility obtains the location of the mobile device 100 automatically using the GPS receiver 107. In some embodiments, the facility performs act 302 by displaying a location selection screen to the user.

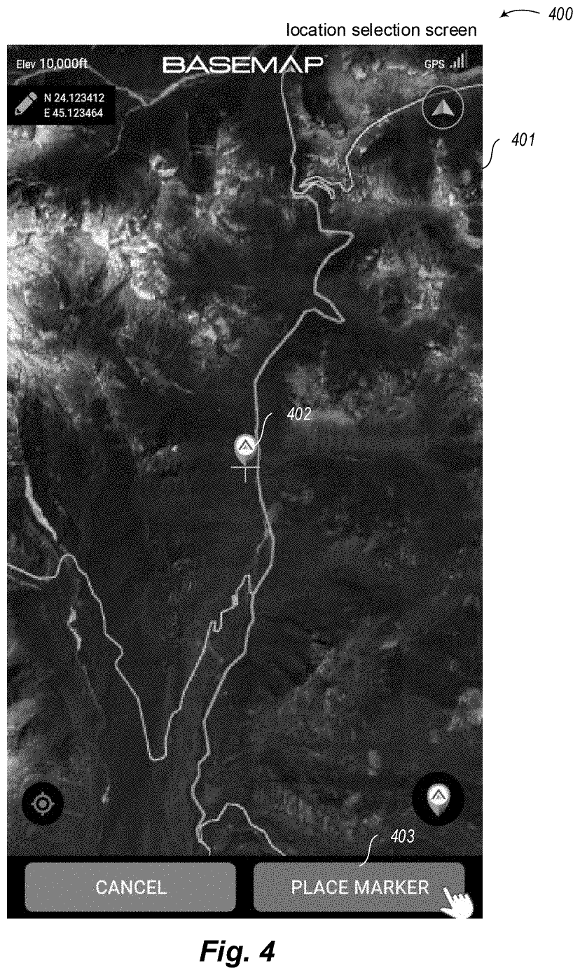

FIG. 4 is a sample location selection screen 400 presented by the facility in some embodiments. The location selection screen 400 includes a map 401 of the geographic area containing the mobile device's 100 location; a marker 402 is included in the center of the map 401; and a place marker button 403 is included in the bottom right corner of the location selection screen 400. In operation, the user manipulates the map 401 by scrolling or zooming in or out, and the marker 402 remains in the center of the location selection screen 400, thus moving to a new geographic location in the context of the map. When the user activates the place marker button 403, the facility uses the geographic location represented by the position of the marker 402 to specify the location of the geographic marker. In some embodiments, the facility initializes the location selection screen 400 to the current location of the mobile device 100, so the user can immediately activate the place marker button 403 to use the current location of the mobile device 100 as the geographic location of the marker.

Returning to FIG. 3, in act 303, the facility receives user input specifying identifying information for the geographic marker. In some embodiments, as part of performing act 303, the facility displays a marker log screen to the user.

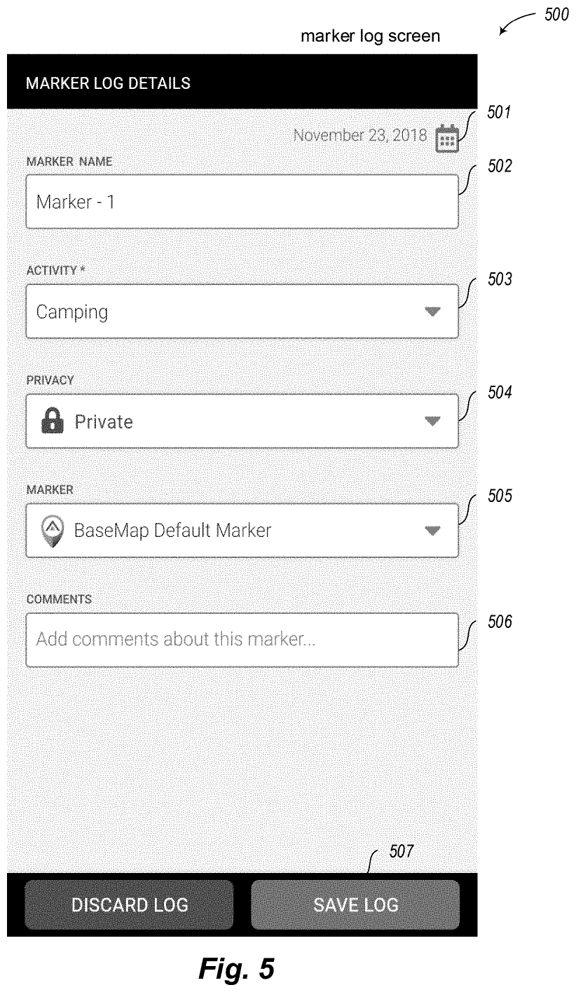

FIG. 5 is a sample marker log screen 500 presented by the facility in some embodiments. The marker log screen 500 includes a date and time selector 501; a name text box 502; an activity dropdown 503; a privacy dropdown 504; a marker type dropdown 505; a comments text box 506; and a save button 507. The date and time selector 501 displays the current date, and allows the user to change the date and time stored in the marker. The name text box 502 allows the user to input text specifying the name of the marker. The activity dropdown 503 allows the user to select an activity from a list of activities. The privacy dropdown 504 allows the user to select a privacy setting from a list of settings, which determine if the marker is visible to others. The marker type dropdown 505 allows a user to select a descriptive type to the marker from a list of types, such as shelter, road entrance, etc. The comments text box 506 allows a user to input text specifying any comment they would like to make about the marker, such as information recording the types of wildlife they encountered, the types of flora they encountered, whether they would like to visit again, etc. When the user has finished inputting the identifying information for the geographic marker, the user activates the save button 507.

Returning to FIG. 3, in act 304, the facility records the current time and date. In some embodiments (not shown), the facility records a user-specified time and date instead of the current time and date. In act 305, the facility retrieves environmental information describing the geographic location at the current time and date, and displays a marker weather conditions screen to the user. In some embodiments, the facility retrieves environmental information from one or more data sources, such as through crowd-sourced data, weather stations, databases of weather and/or environment information, other users, etc.

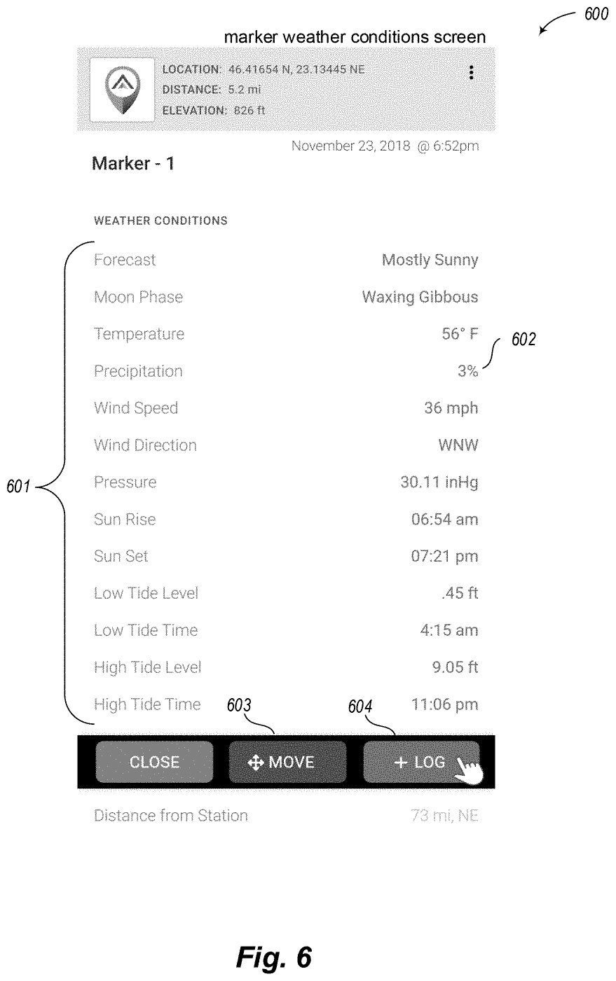

FIG. 6 is a sample marker weather conditions screen 600 presented by the facility in some embodiments. The marker weather conditions screen 600 includes a weather conditions display 601, a move button 603, and a log button 604. The weather conditions display 601 displays some or all of the environmental information retrieved in act 305. In some embodiments, the weather conditions display 601 indicates a weather condition and its value, such as the precipitation value 602. If a user interacts with one of the values, such as the precipitation value 602, they are able to adjust the value to correct any errors or fill in data they have gathered themselves. In some embodiments, the user can adjust a value using a data adjustment screen, reached in some embodiments by tapping on the value to be adjusted.

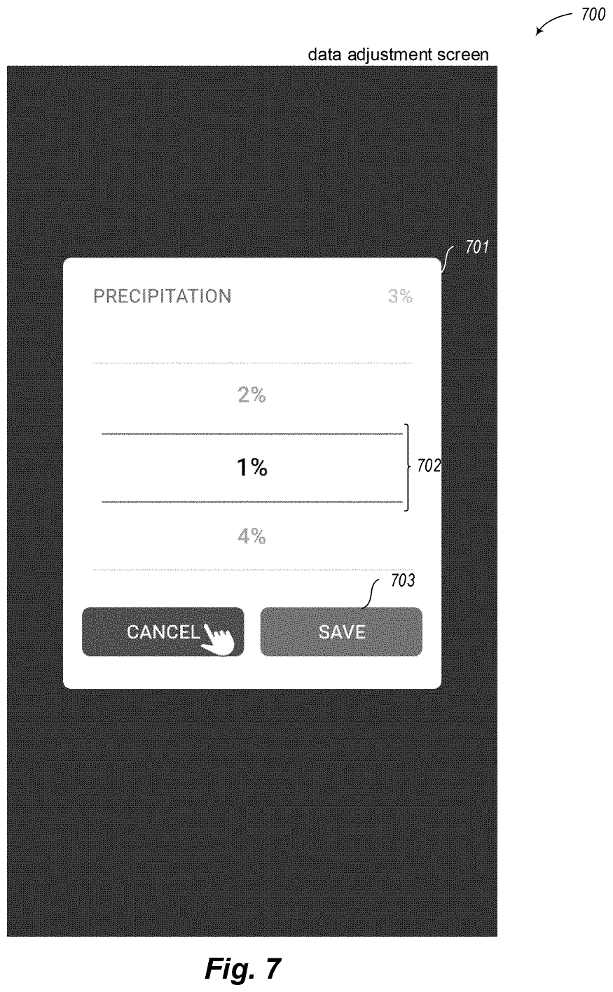

FIG. 7 is a sample data adjustment screen 700 presented by the facility in some embodiments. The data adjustment screen 700 includes a data adjustment dialog 701, a value spinner 702, and a save button 703. The data adjustment dialog 701 displays the current weather information value, and can include one or more from a multitude of data entry dialogs, such as a spinner, a dropdown box, text input, radio buttons, check-boxes, etc. The value spinner 702 allows a user to select a value from a list of values, by manipulating the spinner to move up or down. When the user has finished inputting data representing the new value, the user activates the save button 703 and the facility adjusts the retrieved environmental information according to the new value.

Returning to FIG. 6, when the user activates the move button 603 the user can adjust the location of the geographic marker retrieved in act 302. In some embodiments, the move button 603 displays another screen, such as the location selection screen 400, in order to retrieve the new location. When the user activates the log button 604, the facility saves the environmental information displayed on the marker weather conditions screen 600.

Returning to FIG. 3, in act 306, the facility uses the identifying information received in act 303, the location received in act 302, the time and date received in act 304, and the environment information retrieved in act 305 to create a geographic marker data structure, and stores the geographic marker data structure in the memory 102 or persistent storage 103.

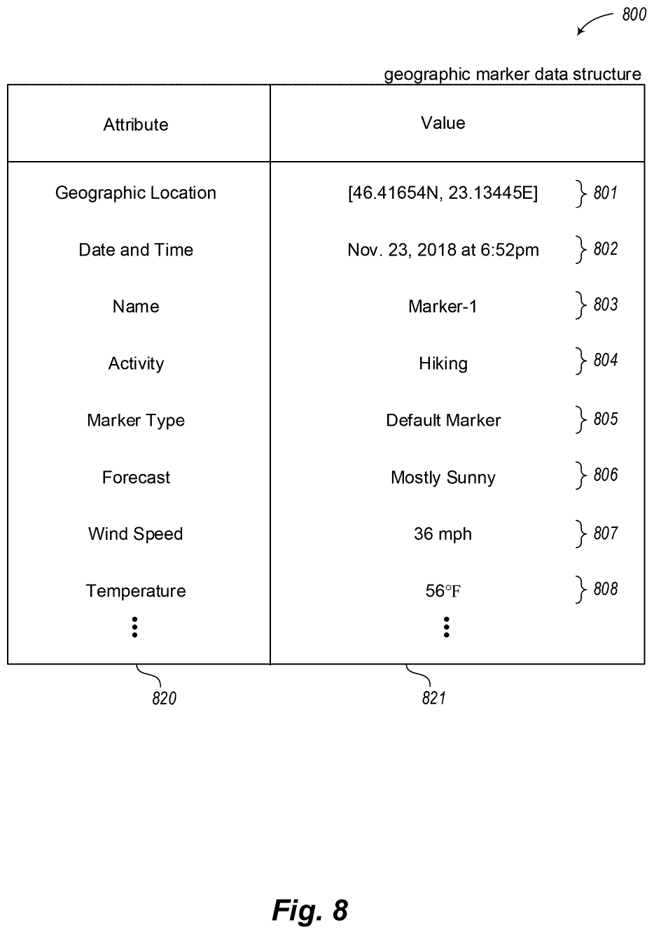

FIG. 8 is a sample geographic marker data structure 800 used by the facility in some embodiments. The geographic marker data structure 800 has Attributes 820 and Values 821 each corresponding to one of the Attributes 820. In some embodiments, the geographic marker data structure 800 has a Geographic Location attribute which indicates a value of “[46.1654N, 23.13445E]”, as shown in row 801.

Returning to FIG. 3, in act 307, the facility displays a map of the area containing the geographic marker, and the geographic marker is included on the map in a location which indicates the location received in act 302. In some embodiments, the geographic marker is included in a list of geographic markers, with the identifying information received in act 303 used to identify the geographic marker. In some embodiments, when the user interacts with the geographic marker included on the map, the facility displays the marker weather conditions screen 600 to the user. In some embodiments, the user may adjust or edit the data stored by the geographic marker data structure 800, by using the weather conditions screen 600 or the marker log screen 500, after creating the marker. In some embodiments, the user shares the geographic marker by posting it to a social media provider.

FIG. 9 is a flow diagram showing a process performed by the facility in some embodiments to create an image marker. In act 901, the facility receives user input specifying the creation of a geographic marker, such as selection of the add photo button 201 shown in FIG. 2. In act 902, the facility receives user input specifying an image. In some embodiments, the facility prompts the user to capture an image with a camera. In some embodiments, the facility prompts the user to specify a file path indicating an image. In some embodiments, the facility prompts the user to specify an image, and the facility determines the file path which indicates the image. In some embodiments, as part of performing act 902, the facility displays an add photo prompt.

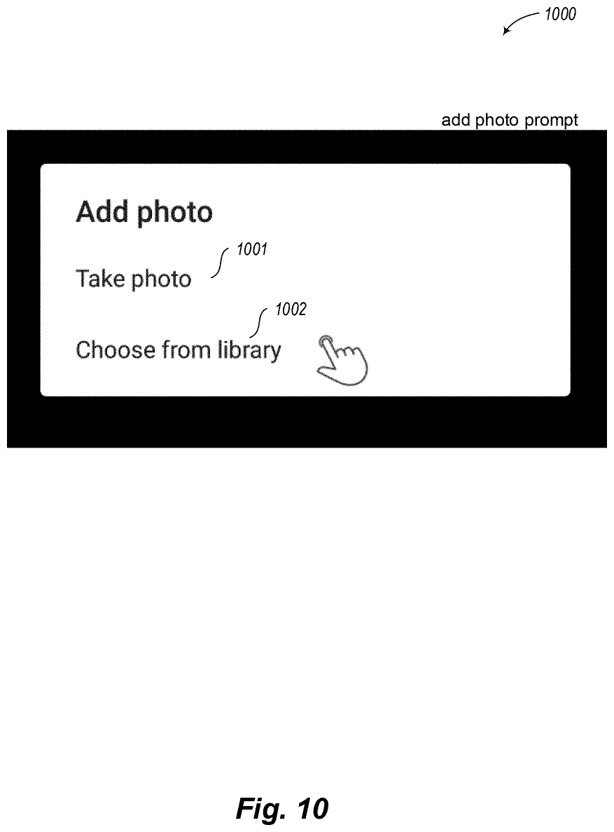

FIG. 10 is a sample add photo prompt 1000, used by the facility in some embodiments. The add photo prompt 1000 contains a take photo button 1001 and a choose from library button 1002. When the user activates the take photo button 1001, the facility activates a camera and allows the user to capture an image using the camera. In some embodiments, the image captured by the user includes EXIF data, and the facility determines the location of the mobile device—and performs act 903—by retrieving the location stored in the EXIF data. When the user activates the choose from library button 1002, the facility displays a list of images, retrieved from the Internet, memory 102 or persistent storage 103 of the mobile device 100, or an image repository, and prompts the user to choose an image from the list of images. In some embodiments, the image chosen by the user includes EXIF data, and the facility determines the location of the mobile device—and performs act 903—by retrieving the location stored in the EXIF data.

Returning to FIG. 9, in act 903, the facility receives user input specifying a location. In some embodiments, the facility obtains the location of the mobile device 100 automatically using the GPS receiver 107. In some embodiments, the image data includes EXIF data and the facility obtains the location from the image's metadata. In some embodiments, the facility performs act 903 by using a location selection screen for image marker.

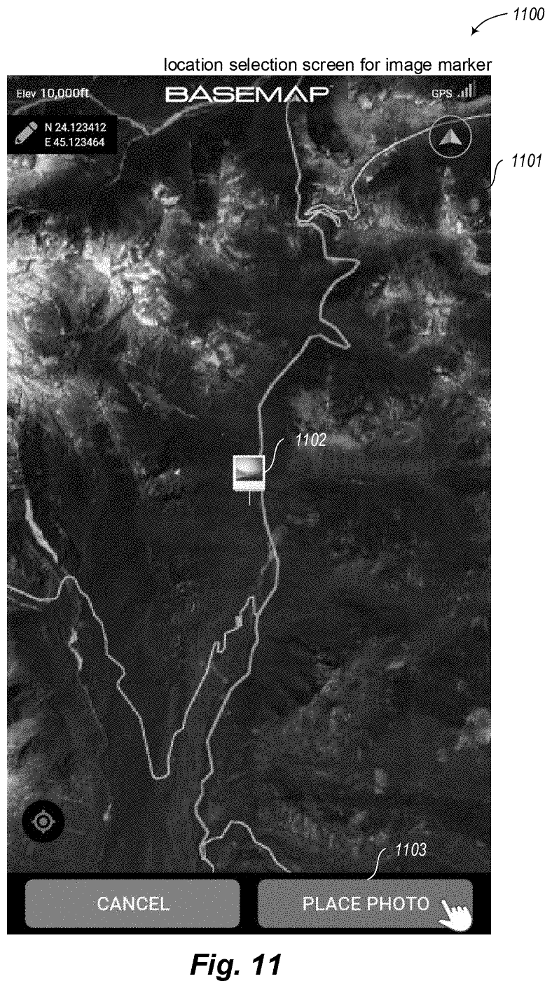

FIG. 11 depicts a sample location selection screen for image marker 1100 presented by the facility in some embodiments. The location selection screen for image marker 1100 includes a map 1101 of the geographic area containing the mobile device's 100 location; an image marker icon 1102 included in the center of the map 1101; and a place photo button 1103 included in the bottom right corner of the location selection screen 1100. In operation, the user manipulates the map 1101 by scrolling or zooming in or out, and the image marker icon 1102 remains in the center of the location selection screen 1100, thus coming to a new geographic location in the context of the map. When the user activates the place photo button 1103, the facility uses the geographic location represented by the position of the image marker icon 1102 to specify the location of the image marker. In some embodiments, the image marker icon 1102 displays the image indicated by the user in act 902. In some embodiments, the facility initializes the location selection screen for image marker 1100 to the current location of the mobile device 100, so the user can immediately activate the place photo button 1103 to use the current location of the mobile device 100 as the geographic location of the image marker. In some embodiments, the image obtained in act 902 includes EXIF data, and the facility performs act 903 by retrieving the location from the location stored in the image's EXIF data.

Returning to FIG. 9, acts 904-906 proceed in a similar manner to acts 303-305. In act 907, the facility uses the identifying information received in act 704, the location received in act 903, the time and date received in act 905, the environment information retrieved in act 906, and the image specified in act 902 to create an image marker data structure, and stores the image marker data structure in the memory 102 or persistent storage 103.

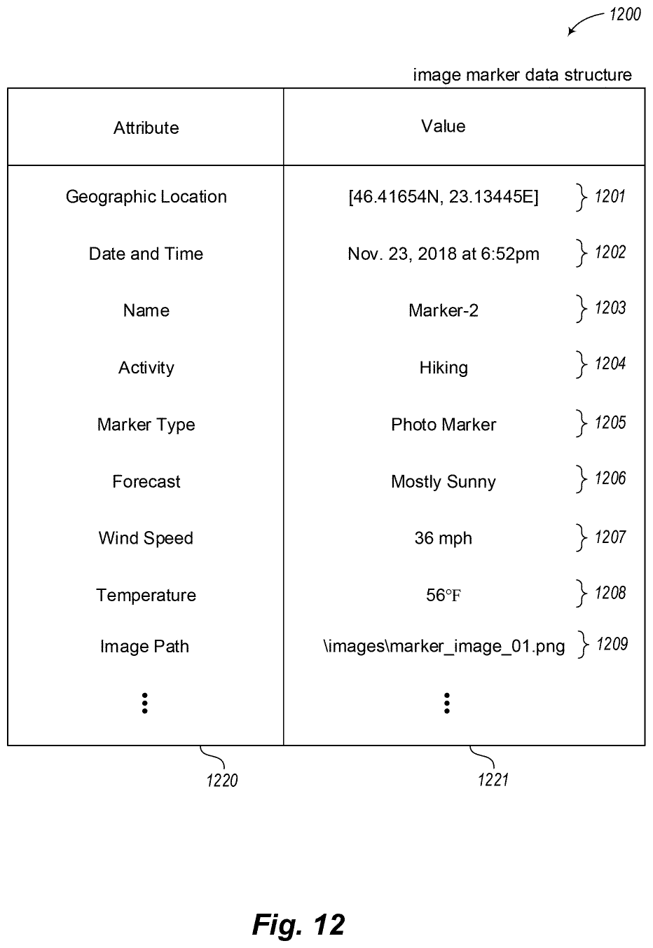

FIG. 12 depicts a sample image marker data structure 1200, used by the facility in some embodiments. The image marker data structure 1200 has Attributes 1220 and Values 1221 each corresponding to one of the Attributes 1220. In some embodiments, the image marker data structure 1200 has a Geographic Location attribute which indicates a value of “[46.1654N, 23.13445E]”, as shown in row 1201. In some embodiments, the image marker data structure 1200 indicates the image data specified in act 902 by using an image path as shown in row 1209. In some embodiments (not shown), the image marker data structure 1200 indicates the image data specified in act 902 by directly containing the image data.

Returning to FIG. 9, in act 908, the facility displays a map of the area containing the image marker, and the image marker is included on the map in a location which indicates the location received in act 903. In some embodiments, the image marker is included in a list of image markers, with the identifying information received in act 904 used to identify the image marker. In some embodiments, an icon containing the image indicated in act 902 represents the image marker on the map. In some embodiments, when the user interacts with the image marker on the map, the facility displays the marker weather conditions screen 600 to the user. In some embodiments, the user may adjust or edit the data stored by the image marker data structure 1200, through the weather conditions screen 600 or the marker log screen 500, after creating the image marker. In some embodiments, the user shares the image marker by posting it to a social media provider.

FIG. 13 is a flow diagram showing a process performed by the facility in some embodiments to create a path. In act 1301, the facility receives user input specifying the creation of a path at a path start screen, such as selection of the record track button 203 shown in FIG. 2.

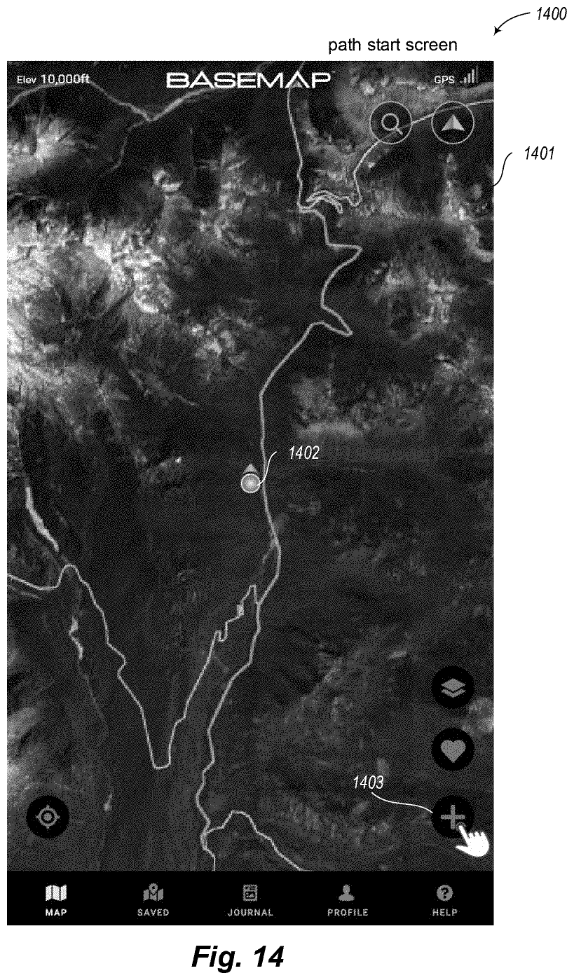

FIG. 14 is a sample path start screen 1400, presented by the facility in some embodiments. The path start screen 1400 includes a map 1401, a current location marker 1402, and an options button 1403. The map 1401 depicts a geographic area containing the mobile device's 100 current geographic location. The current location marker 1402 depicts the mobile device's 100 current geographic location on the map 1401. The options button 1403 contains options for the user to select, including the option to begin recording a path. The user activates the options button 1403, which displays a list of options, allowing user to indicate to the facility to start recording a path.

Returning to FIG. 13, in act 1302 the facility records the current time and date in a manner similar to act 304. In act 1303, the facility determines its geographic location, and records the geographic location. In some embodiments, the facility determines its geographic location using a GPS receiver 107. At step 1304, if the user does not request the recording to stop, the process returns to act 1303 and repeats until the user indicates the recording should stop. While the recording continues, the facility displays a path map screen and records intermediate geographic locations at predetermined time intervals.

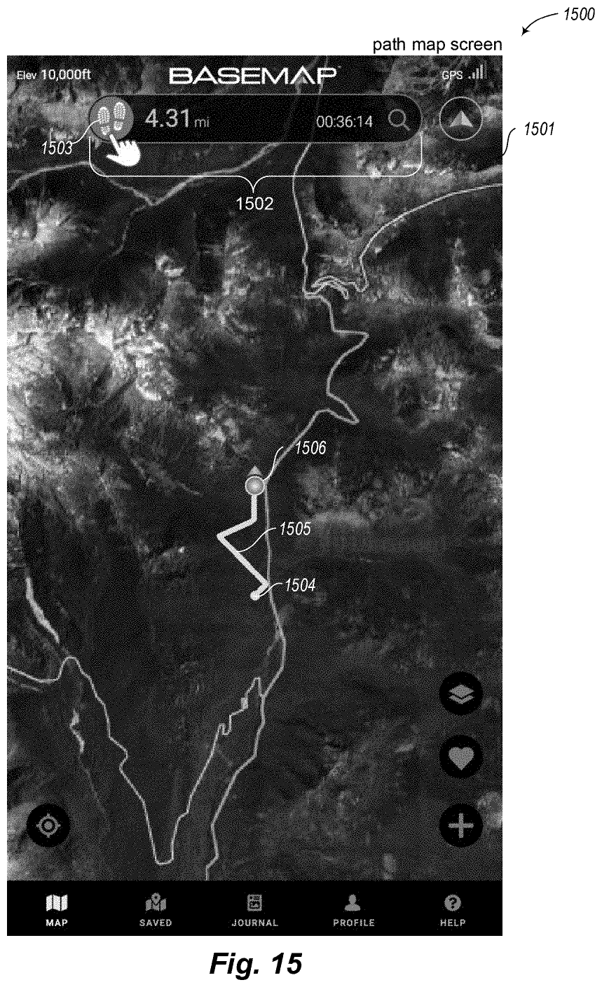

FIG. 15 is a sample path map screen 1500, presented by the facility in some embodiments. The path map screen 1500 includes a map 1501, a path progress tracker 1502, a path progress button 1503, a path start point 1504, a path progress line 1505, and a path endpoint 1506. The map 1501 depicts an area around the mobile device's 100 current geographic location. The path progress tracker 1502 displays the total distance covered along the path and the total time the facility has been recording the path. The path progress button 1503 opens a path progress screen, displaying information describing the path. The path start point 1504 depicts the geographic location where the user began recording the path. The path progress line 1505 depicts the movement of the user through each of the intermediate geographic locations recorded in acts 1303 and 1304. The path endpoint 1506 displays the current endpoint of the path, which also corresponds to the user's current location.

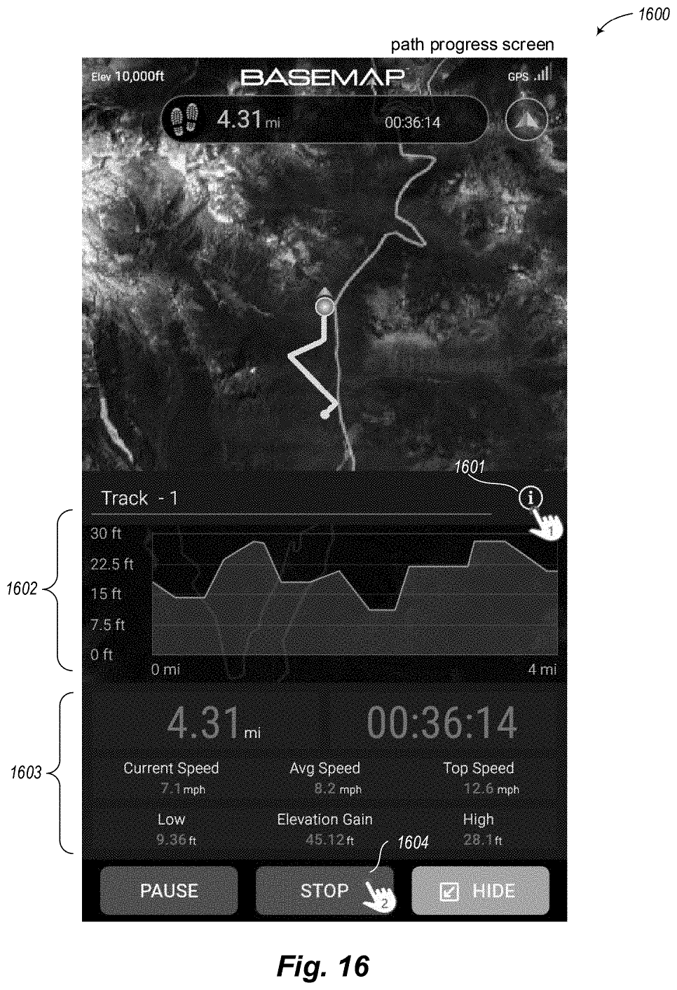

FIG. 16 is a sample path progress screen 1600, presented by the facility in some embodiments. The path progress screen 1600 includes an information button 1601, an elevation tracker 1602, a path information tracker 1603, and a stop button 1604. When a user activates the information button 1601, the facility displays a path weather conditions screen 1800. The elevation tracker 1602 displays the user's elevation at the beginning, intermediate, and final geographic locations in the path. The path information tracker 1603 displays information about the user's travel along the path, such as the total time, distance traveled, current speed, average speed, top speed, the lowest elevation, the highest elevation, and the total elevation gain. When the user activates the stop button 1604, the facility stops recording geographic locations and moves on to act 1305. In some embodiments, if all of the intermediate geographic locations are for the same geographic location as the first geographic location, the facility cancels the creation of the path, and the process ends here.

Returning to FIG. 13, in act 1305, the facility records a second time and date. In act 1306, the facility receives user input specifying identifying information for the path using a path log screen.

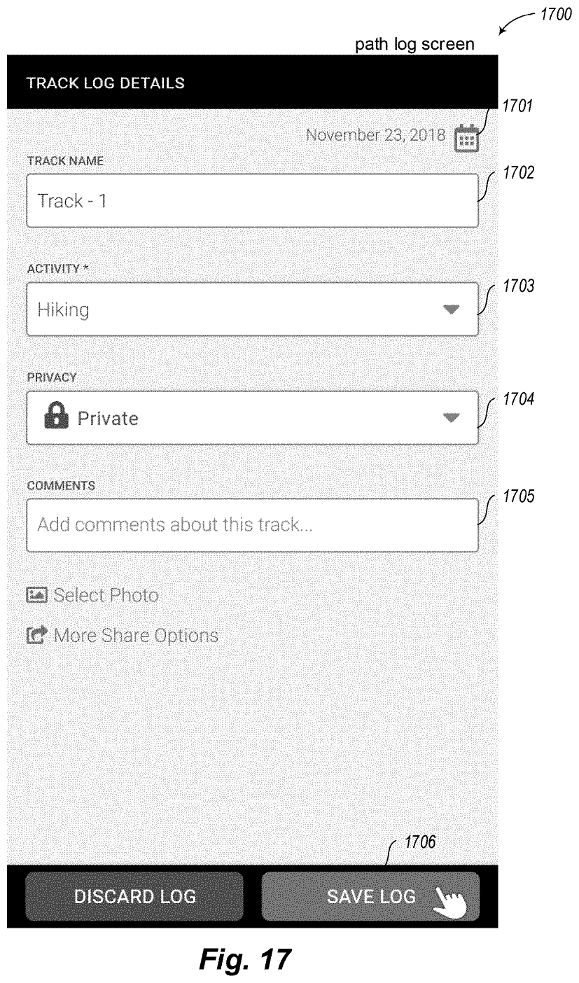

FIG. 17 is a sample path log screen 1700, presented by the facility in some embodiments. The path log screen 1700 includes a date and time selector 1701; a name text box 1702; an activity dropdown 1703; a privacy dropdown 1704; a comments text box 1705; and a save button 1706. The date and time selector 1701 displays the second date recorded in act 1305, and allows the user to change the second time and date recorded in act 1705. The name text box 1702 allows the user to input text specifying the name of the path. The activity dropdown 1703 allows the user to select an activity from a list of activities. The privacy dropdown 1704 allows the user to select a privacy setting from a list of settings, which determines if the path is visible to others. The comments text-box 1705 allows a user to input text specifying any comment they would like to make about the path, such as information recording the types of wildlife they encountered, the types of flora they encountered, whether they would like to visit again, etc. When the user has finished inputting the identifying information, the user activates the save button 1706. In some embodiments, the user can add an image to a path at the path log screen 1700, such as by using an add photo prompt 1000, reached in some embodiments by tapping a select photo button.

In act 1307, the facility retrieves environmental information describing the first recorded geographic location at the first time and date in a manner similar to act 305. In act 1308, the facility retrieves environmental information for the last recorded geographic location at the second date and time, in a manner similar to act 305. In some embodiments, the facility also displays a path weather conditions screen after performing act 1308.

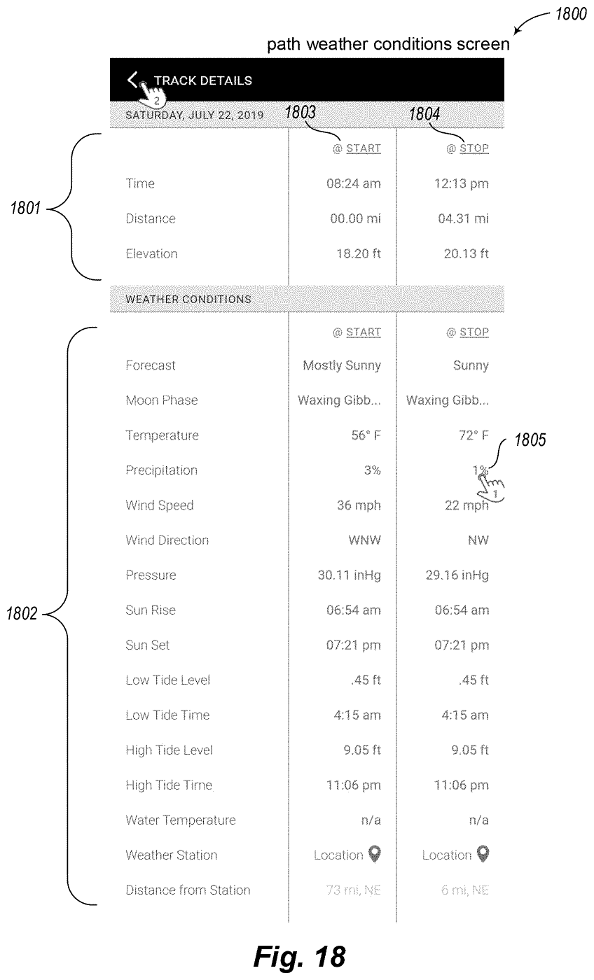

FIG. 18 is a sample path weather conditions screen 1800, presented by the facility in some embodiments. The path weather conditions screen 1800 includes a path details section 1801, a path weather conditions section 1802, a start column 1803, and a stop column 1804. The path details section 1801 includes information split into a start column 1803 and a stop column 1804. The path details section 1801 includes information regarding the time, distance, and elevation at the start of the path in the start column 1803, and information regarding the time, distance, and elevation at the end of the path in the stop column 1804. The path weather conditions section 1802 includes information regarding the weather conditions on the path split into a start column 1803 and a stop column 1804. The path weather conditions section 1802 includes information including the forecast, precipitation, pressure, wind speed, etc. at the start of the path in the start column 1803, and includes the information including the forecast, precipitation, pressure, wind speed, etc. at the end of the path in the stop column 1804. The user can adjust a value, such as the precipitation value 1805, using the data adjustment screen 700, reached in some embodiments by tapping on the value to be adjusted.

Returning to FIG. 13, in act 1309, the facility uses the environmental information, geographic locations, identifying information, and both times and dates to create a path data structure, which is stored in the memory 102 or persistent storage 103.

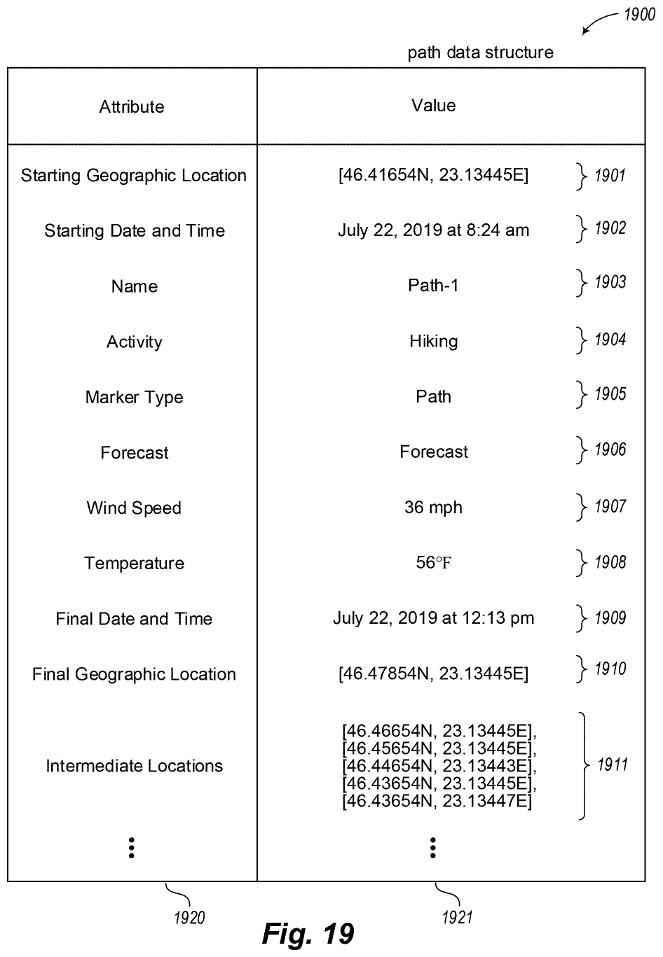

FIG. 19 is a sample path data structure 1900, used by the facility in some embodiments. The path data structure 1900 has Attributes 1920 and Values 1921 each corresponding to one of the Attributes 1920. In some embodiments, the path data structure has a Starting Geographic Location attribute which is stored as “[46.41654N, 23.13445E]” in row 1901, a Final Geographic Location stored as “[46.47854N, 23.13445E]” in row 1910, and Intermediate Locations stored as “[46.46654N, 23.13445E], [46.45654N, 23.13445E], [46.44654N, 23.13443E], [46.43654N, 23.13445E], [46.43654N, 23.13447E]” in row 1911.

Returning to FIG. 13, in act 1310, the facility displays the path on a map containing the geographic area that contains the path, such as in a path display screen. In some embodiments, the path is displayed in a list of paths, with the identifying information received in act 1306 used to identify the path. In some embodiments, when the user interacts with the path on the map, the facility displays the path progress screen 1600 to the user. In some embodiments, the user may adjust or edit the data stored by the path data structure 1900, by using the path weather conditions screen 1800 or the path log screen 1700, after creating the path. In some embodiments, the user shares the path with others by posting it to a social media provider.

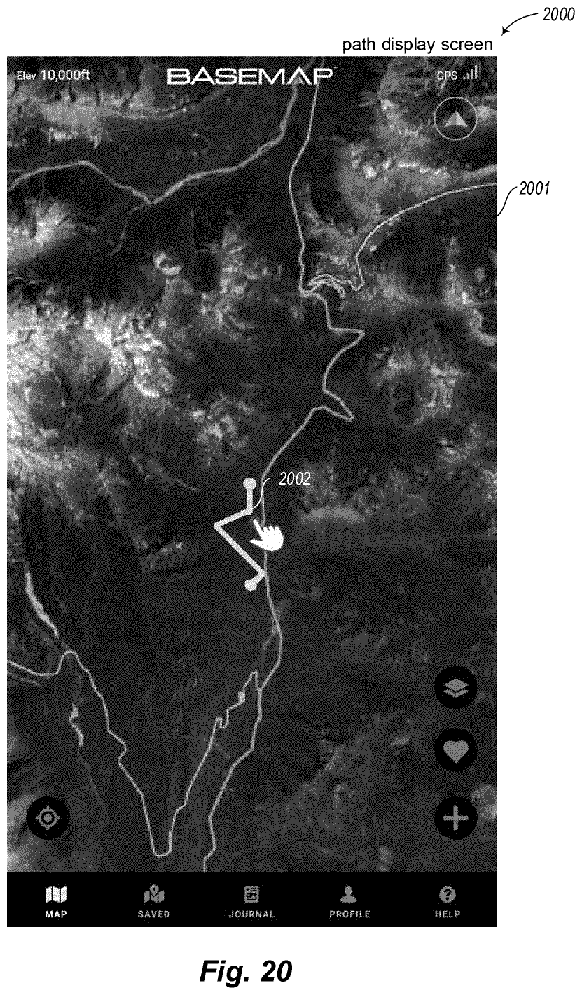

FIG. 20 is a sample path display screen 2000, presented by the facility in some embodiments. The path display screen 2000 has a map 2001 and a path line 2002. The map 2001 is a map of a geographic area containing the first geographic location of a path and the last geographic location of a path. In operation, the user manipulates the map 2001 by scrolling or zooming in or out. The path line 2002 is included in the map 2001, such that one point of the path line 2002 is displayed at a point on the map represented by the first geographic location, the other point of the path line 2002 is displayed at a point on the map represented by the final geographic location, and the path line 2002 passes through points on the map represented by the intermediate locations of the path. In some embodiments, when the user selects the path line 2002, the facility displays the path progress screen 1600.

In some embodiments, the map 401, map 1101, map 1401, map 1501, map 2001, or any other map displayed by the facility can display zero or more paths, zero or more geographic markers, or zero or more image markers. In some embodiments, the facility includes a social media provider which allows users to interact and share their saved paths, geographic markers, and image markers. In some embodiments, when the time and date for a geographic marker, path, or image marker is changed, the facility retrieves environmental information for the geographic location at the changed time, as it does in acts 305, 1307 and 1308, and 906 respectively.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. One or more instances of computer-readable media collectively having contents configured to cause a mobile device to perform a method for storing a geographic marker containing environmental information, the method comprising:
receiving, at a distinguished date and time, user input specifying the creation of a geographic marker; and
in response to receiving the user input:
determining a geographic location of the mobile device at the distinguished date and time;
retrieving environmental information characterizing the geographic location at the distinguished date and time, the retrieved environmental information including weather information; and
storing a geographic marker containing the determined geographic location, the distinguished date and time, and the retrieved environmental information.

2. The one or more instances of computer-readable media of claim 1, the method further comprising:
causing the mobile device to display the determined geographic location, the distinguished date and time, and the retrieved environmental information contained in the stored geographic marker.

3. The one or more instances of computer-readable media of claim 1, the method further comprising:
receiving additional user input specifying image data; and
altering the geographic marker to contain the specified image data.

4. The one or more instances of computer-readable media of claim 1, the method further comprising:
receiving user input specifying a date and time later than the distinguished date and time;
retrieving future environmental information characterizing the geographic location at the later date and time, the retrieved future environmental information including weather information; and
altering the stored geographic marker to contain the later date and time and the future environmental information.

5. The one or more instances of computer-readable media of claim 1, the method further comprising:
receiving user input specifying a date and time earlier than the distinguished date and time;
retrieving past environmental information characterizing the geographic location at the earlier date and time, the retrieved past environmental information including weather information; and
altering the geographic marker to contain the earlier date and time and the past environmental information.

6. The one or more instances of computer-readable media of claim 1, the method further comprising:
storing one or more intermediate geographic locations of the mobile device, each at a time after the distinguished date and time;
receiving additional user input at a second distinguished date and time;
determining a final geographic location of the mobile device at the second distinguished date and time;
retrieving second environmental information characterizing the final geographic location at the second distinguished date and time, the retrieved second environmental information including weather information; and
altering the geographic marker to contain the determined final geographic location, the second distinguished date and time, the retrieved second environmental information, and the one or more intermediate geographic locations in addition to the determined geographic location, the distinguished date and time, and the retrieved environmental information.

7. The one or more instances of computer-readable media of claim 6, the method further comprising:
displaying a map representing a geographic area containing the determined geographic location, final geographic location, and intermediate geographic locations; and
displaying in connection with the map a visual path from the determined geographic location to the final geographic location that passes through the intermediate geographic locations.

8. The one or more instances of computer-readable media of claim 1, the method further comprising posting the geographic location, environmental information, and distinguished date and time contained in the geographic marker to a social media platform.

9. One or more storage devices collectively storing a geographic marker data structure, the data structure comprising:
information specifying a date and time at which a geographic marker was created; and
information specifying a geographic location determined for the geographic marker,
such that the contents of the data structure are usable to display information describing the geographic location relative to the date and time.

10. The one or more storage devices of claim 9, wherein the data structure further comprises information specifying environmental data describing the geographic location at the distinguished date and time.

11. The one or more storage devices of claim 10, wherein the environmental data further comprises weather data.

12. The one or more storage devices of claim 9, wherein the data structure further comprises information specifying an image captured at the specified geographic location at the specified date and time.

13. The one or more storage devices of claim 9, wherein the data structure further comprises:
information specifying one or more geographic locations, determined after the geographic marker was created;
information specifying a second date and time, at which a final geographic location is determined;
information specifying a final geographic location;
information specifying environmental data describing the geographic location at the date and time at which the geographic marker was created; and
information specifying a second environmental data describing the final geographic location at the second date and time,
such that, the contents of the data structure can be used to represent a path from the geographic location to the final geographic location.

14. The one or more storage devices of claim 10, wherein the data structure further comprises:
information specifying a second date and time other than the date and time the geographic marker was created; and
information specifying second environmental data describing the geographic location at the second date and time.

15. A method in a mobile device, the method comprising:
receiving, at a distinguished date and time, user input specifying the creation of a geographic marker; and
in response to receiving the user input:
determining a geographic location of the mobile device at the distinguished date and time; and
storing a geographic marker indicating the determined geographic location and the distinguished date and time.

16. The method of claim 15, the method further comprising:
in response to receiving the user input:
retrieving environmental information describing the geographic location at the distinguished date and time; and
altering the geographic marker to indicate the retrieved environmental information.

17. The method of claim 16, wherein the environmental information further comprises weather information.

18. The method of claim 15, the method further comprising displaying the determined geographic location and the distinguished date and time.

19. The method of claim 15, the method further comprising:
receiving additional user input specifying image data; and
altering the geographic marker to indicate the specified image data.

20. The method of claim 16, the method further comprising:
retrieving a date and time later than the distinguished date and time from additional user input;
retrieving future environmental information describing the geographic location at the later date and time; and
altering the geographic marker to indicate the later date and time and the future environmental information.

21. The method of claim 16, the method further comprising:
retrieving a date and time earlier than the distinguished date and time from additional user input;
retrieving past environmental information describing the geographic location at the earlier date and time; and
altering the geographic marker to indicate the earlier distinguished date and time and the past environmental information.

22. The method of claim 15, the method further comprising:
storing one or more intermediate geographic locations of the mobile device, each at a time later than the distinguished date and time;
receiving additional user input at a second distinguished date and time;
determining a final geographic location of the mobile device at the second distinguished date and time; and
altering the geographic marker to indicate the determined final geographic location, the second distinguished date and time, and the intermediate geographic locations.

23. The method of claim 22, the method further comprising:
displaying a map representing the geographic area containing the determined geographic location, final geographic location, and intermediate geographic locations; and
displaying in connection with the map, a visual path from the determined geographic location to the final geographic location that passes through the intermediate geographic locations.

24. The method of claim 15, the method further comprising posting the determined geographic location and the distinguished date and time indicated by the geographic marker on a social media platform.

25. A method to display geographic marker data on a mobile device, the method comprising:
displaying a visual indication of the geographic location stored in the geographic marker data; and
simultaneously with the visual indication, displaying a date and time the geographic marker was created.

26. The method of claim 25, the method further comprising:
displaying a map representing a geographic area containing the geographic location; and
displaying a marker at a point on the map representing the geographic location.

27. The method of claim 25, the method further comprising displaying image data stored in the geographic marker data.

28. The method of claim 25, the method further comprising displaying environmental information describing the geographic location at the date and time the marker was created.

29. The method of claim 28, wherein the environmental information further comprises weather information.

30. The method of claim 28, the method further comprising displaying environmental information describing the geographic location at a time before the date and time the marker was created.

31. The method of claim 28, the method further comprising displaying environmental information describing the geographic location at a time after the date and time the marker was created.

32. The method of claim 25, the method further comprising:
displaying a visual indication of one or more intermediate geographic locations stored in the geographic marker data;
displaying a visual indication of a final geographic location stored in the geographic marker data;
displaying the date and time stored in the geographic marker data at which the mobile device was located at each of the one or more intermediate geographic locations; and
displaying the date and time stored in the geographic marker data at which the mobile device was located at the final geographic location.

33. The method of claim 26, the method further comprising:
displaying a marker at a point on the map representing the final geographic location;
displaying a point on the map representing one or more intermediate geographic locations; and
displaying a path connecting the point on the map representing the geographic location to the point on the map representing the final geographic location, such that the path connects the point on the map representing the geographic location to each point on the map representing the one or more intermediate geographic locations, and ends at the point on the map representing the final geographic location.
